(19) United States
(12) Patent Application Publication
(10) Pub. No.: US 2003/0161047 A1
(43) Pub. Date: Aug. 28, 2003

(54) Optical apparatus having multiple arrays of one-dimensional optical elements

(76) Inventors: Chih-Kung Lee, Taipei (TW); Ching-Heng Tang, Taipei (TW); Ching-Hua Lee, Taoyuan (TW); Yuh-Luen Juh, Taipei (TW); Chia-Yi Chen, Taipei County (TW); Yue-Shih Jeng, Miaoli (TW); Chuan-Fa Lee, Penghu (TW); Liang-Bin Yu, Taipei County (TW); Chia-Lung Lin, Taoyuan (TW); Shang-Yao Lin, Taipei (TW)

Correspondence Address: KAO H. LU, 686 LAWSON AVE, HAVERTOWN, PA, 19083, US

(21) Appl. No.: 10/368,178

(22) Filed: Feb. 18, 2003

(30) Foreign Application Priority Data
Feb. 26, 2002 (TW) 91103488

(51) Int. Cl. G02B 27/10

(52) U.S. Cl. 359/624

(57) ABSTRACT

An optical apparatus made for either imaging or light-blurring application is disclosed. The optical apparatus has two arrays of one-dimensional optical elements. Each of the two arrays has a number of elongated cylindrical optical elements arrayed consecutively in parallel and spreading along a first extension-profiling direction generally orthogonal to their longitudinal axes. The two arrays are superposed together with their general direction extension profile twisted with respect to each other at a selected angle. The superposition spreads an extended layer of optical system having a number of lens units formed from the superposition. All the lens units are arrayed in a two-dimensional matrix of moire fringe. More than two arrays of one-dimensional optical elements can be used to construct an optical apparatus. Factors in the system including the twist angle of superposition, the lens profile of one-dimensional optical elements used, and spacing between the superposed arrays can be adjusted to construct an optical device of designated focusing or defocusing optical characteristics.

### BACKGROUND OF THE INVENTION

1. Field of the Invention

This invention relates in general to an optical apparatus and, in particular, to one having a two-dimensional matrix of optical lens units each constructed for either the imaging or light-blurring application.

2. Technical Background

Miniaturized lens units produced in quantity and arrayed in a large matrix is a form of optical system that finds various applications. Some of these applications intentionally desire their individual lens units to de-focus—blur—their incident lights while others require good focusing of their lens units—precision imaging.

For example, in a liquid crystal display (LCD), light diffuser plate is necessary to blur the surface light source with local areas of bright illumination. Other display or illumination devices have similar problem of different-intensity light spots or small areas. In LED-based traffic lights and automotive tail light assemblies, light spots of each individual LED arranged in a gross matrix need to be smeared. On the other hand, for optical systems with microlens arrays for distributed local imaging, simple and low cost fabrication have always been problem. When precision imaging capability is required for each individual lens unit in the system array, precise control of lens profile shape becomes the utmost issue. It is, however, costly, complex and/or time-consuming to implement repeated precision lens profiling in vast multiplicity since there are usually hundreds or more of individual lens units in the gross matrix. The same is true for blurring optical systems since it takes specific lens profiles to blur images.

Another issue directly related to the efficacy of matrix-based optical systems is aperture ratio, a percentage measure of effective surface area per unit useful in light collection. High aperture ratio implies increased light efficiency, and the reverse is true. To achieve optimized aperture ratio, consecutive lens units in the system matrix need to be connected with each other while still retaining their individual lens profile precision.

### SUMMARY OF THE INVENTION

There is therefore the need for an optical apparatus that can be made at low cost to specific optical characteristics of either controlled blurring of light or precision imaging.

The present invention thus provides an optical apparatus for either imaging or light-blurring application. The optical apparatus has two arrays of one-dimensional optical elements. Each of the two arrays has a number of elongated cylindrical optical elements arrayed consecutively in parallel and spreading along a first extension-profiling direction generally orthogonal to their longitudinal axes. The two arrays are superposed together with their general direction extension profile twisted with respect to each other at a selected angle. The superposition spreads an extended layer of optical system having a number of lens units formed from the superposition. All the lens units are arrayed in a two-dimensional matrix of moire fringe. More than two arrays of one-dimensional optical elements can be used to construct an optical apparatus. Factors in the system including the twist angle of superposition, the lens profile of one-dimensional optical elements used, and spacing between the superposed arrays can be adjusted to construct an optical device of designated focusing or defocusing optical characteristics.

### BRIEF DESCRIPTION OF THE DRAWINGS

Other objects, features, and advantages of the present invention will become apparent by way of the following detailed description of the preferred but non-limiting embodiments. The description is made with reference to the accompanied drawings in which:

FIG. 1 is a perspective view illustrating an array of one-dimensional optical elements of a generally curvilinear extending profile;

FIG. 2 is a perspective view illustrating an array of one-dimensional optical elements of a straight-line extending profile;

FIG. 3 is a perspective view illustrating a portion of an optical apparatus in accordance with a preferred embodiment of the present invention;

FIG. 4 schematically outlines the matrix positioning of portions of the basic optical units in an optical apparatus of the present invention;

FIG. 5 schematically outlines the superposition of two arrays of one-dimensional optical elements of straight-line extension profile and fixed element pitch;

FIG. 6 schematically outlines the superposition of two arrays of one-dimensional optical elements of straight-line extension profiles and both fixed and varied element pitch;

FIG. 7 is a perspective view illustrating one basic optical unit for an optical apparatus of the present invention with an orthogonal twist angle between the two comprising arrays;

FIG. 8 illustrates the footprint of the unit optics of FIG. 7 along the direction of normal optical path;

FIG. 9 is a perspective view illustrating four of the unit optics of FIG. 7 in the vast matrix thereof;

FIG. 10 is a top view outlining the footprint of the group of selected basic unit optics of FIG. 9 and showing a one-hundred-percent aperture ratio;

FIG. 11 is a perspective view illustrating one basic optical unit for an optical apparatus of the present invention with a small twist angle between the two comprising arrays;

FIG. 12 illustrates the footprint of the unit optics of FIG. 11 along the direction of normal optical path;

FIG. 13 is a perspective view illustrating six of the unit optics of FIG. 11 in the vast matrix thereof;

FIG. 14 is a top view outlining the footprint of the group of selected basic unit optics of FIG. 13 and showing a one-hundred-percent aperture ratio;

FIG. 15 is a perspective view illustrating the shape details of a basic optical unit integrated within the main planar body of an optical apparatus of the present invention;

FIG. 16 illustrates the footprint projection of the particular unit optics of [0016] [0022] FIG. 15 along the direction of normal optical path;

FIG. 17 schematically outlines another superposition of two arrays of one-dimensional optical elements with a curvilinear and a straight-line extension profile and having a generally orthogonal twist angle there between;

FIG. 18 schematically outlines yet another superposition of two arrays of one-dimensional optical elements with a curvilinear and a straight-line extension profile and having a small twist angle there between; [00251 FIG. 19 is a perspective view illustrating the shape details of a basic optical unit integrated within the main planar body of an optical apparatus of the present invention having arrays of curvilinear extension profile;

FIG. 20 illustrates the footprint projection of the particular unit optics of FIG. 19 along the direction of normal optical path;

FIG. 21 is a perspective view illustrating another basic optical unit of an optical apparatus of the present invention comprising two arrays of one-dimensional optical elements;

FIG. 22 illustrates the footprint projection of the unit optics of FIG. 21 along the direction of normal optical path;

FIG. 23 is a perspective view illustrating still another basic optical unit of an optical apparatus of the present invention comprising two arrays of one-dimensional optical elements;

FIG. 24 illustrates the footprint projection of the unit optics of FIG. 23 along the direction of normal optical path;

FIG. 25 is a perspective view illustrating yet another basic optical unit of an optical apparatus of the present invention comprising two arrays of one-dimensional optical elements;

FIG. 26 illustrates the footprint projection of the unit optics of FIG. 25 along the direction of normal optical path;

FIG. 27 is a perspective view illustrating yet another basic optical unit of an optical apparatus of the present invention comprising two arrays of one-dimensional optical elements;

FIG. 28 illustrates the footprint projection of the unit optics of FIG. 27 along the direction of normal optical path;

FIG. 29 is a perspective view illustrating one basic optical unit of an optical apparatus of the present invention comprising three arrays of one-dimensional optical elements;

FIG. 30 illustrates the footprint projection of the unit optics of FIG. 29 along the direction of normal optical path;

FIG. 31 is a perspective view illustrating a portion of an optical apparatus in accordance with a preferred embodiment of the present invention featuring one-dimensional optical elements with concave lens profiles;

FIG. 32 is a perspective view illustrating the optical apparatus of FIG. 3 further featuring distributed local ground surface areas; and

FIG. 33 is a perspective view illustrating a portion of an optical apparatus having two arrays of one-dimensional optical elements and sustaining the shape of a generally curved plane.

### DETAILED DESCRIPTION OF THE PREFERRED EMBODIMENTS

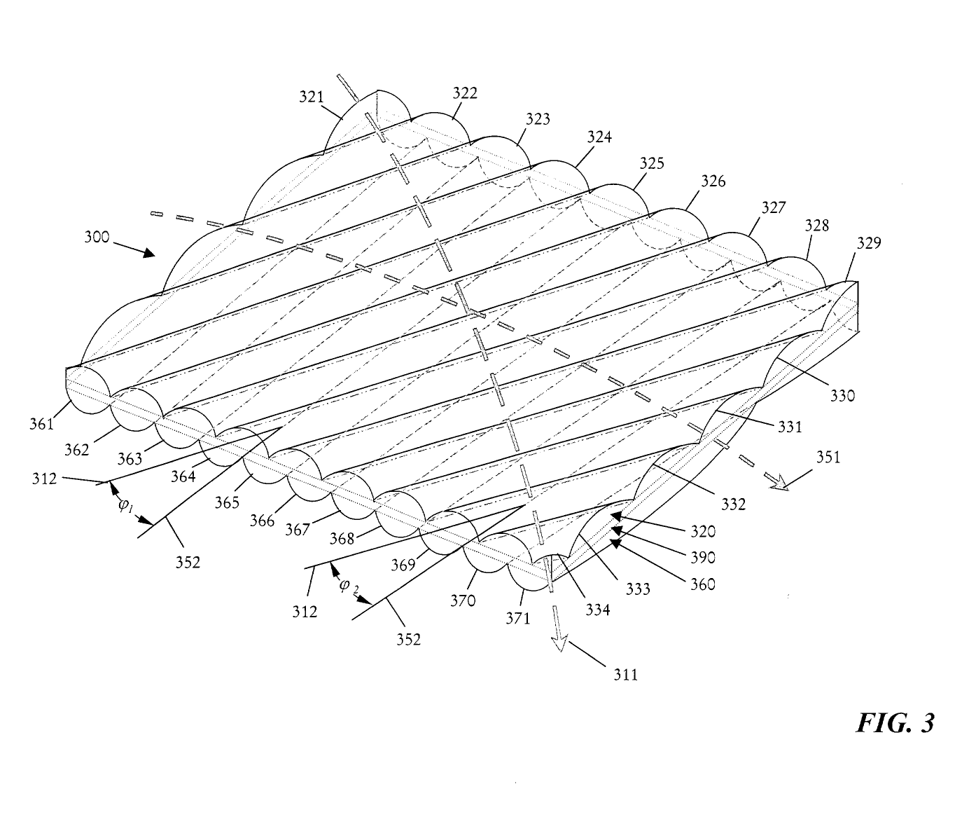

FIG. 3 is a perspective view illustrating a section of the gross of the inventive optical apparatus constructed in accordance with the teaching of the present invention. The illustrated portion of FIG. 3 is a generally rectangular section of the gross planar optical apparatus, which is frequently made into a thin sheet of either flat or curved planar nature. For example, in the illumination light diffusing application for the backlight module of an LCD display, the inventive optical apparatus is made flat while in the LED smearing application for automobile tail light assemblies, it can be made curved.

A preferred embodiment of the inventive optical apparatus such as depicted in FIG. 3 comprises multiple (at least two) arrays of one-dimensional optical elements. As will be described in the following descriptive paragraphs, an optical apparatus of the present invention constructed out of a multiple number of arrays of one-dimensional optical elements is capable of minimized optical loss and optimized optical characteristics. Minimization of optical loss is achievable due to the hundred-percent aperture ratio of each of the constituent lens units in the gross matrix of the inventive optical apparatus. Meanwhile, an optical apparatus of the present invention can be made to the desired optical specification for either the blurring or imaging application simply via adjustment of a few easy-to-control design parameters. These include the optical surface profile of the one-dimensional optical elements in the arrays, the spacing and the relative twist angle between the superposed arrays, and the pitch and the extension profile for optical elements in the arrays, etc.

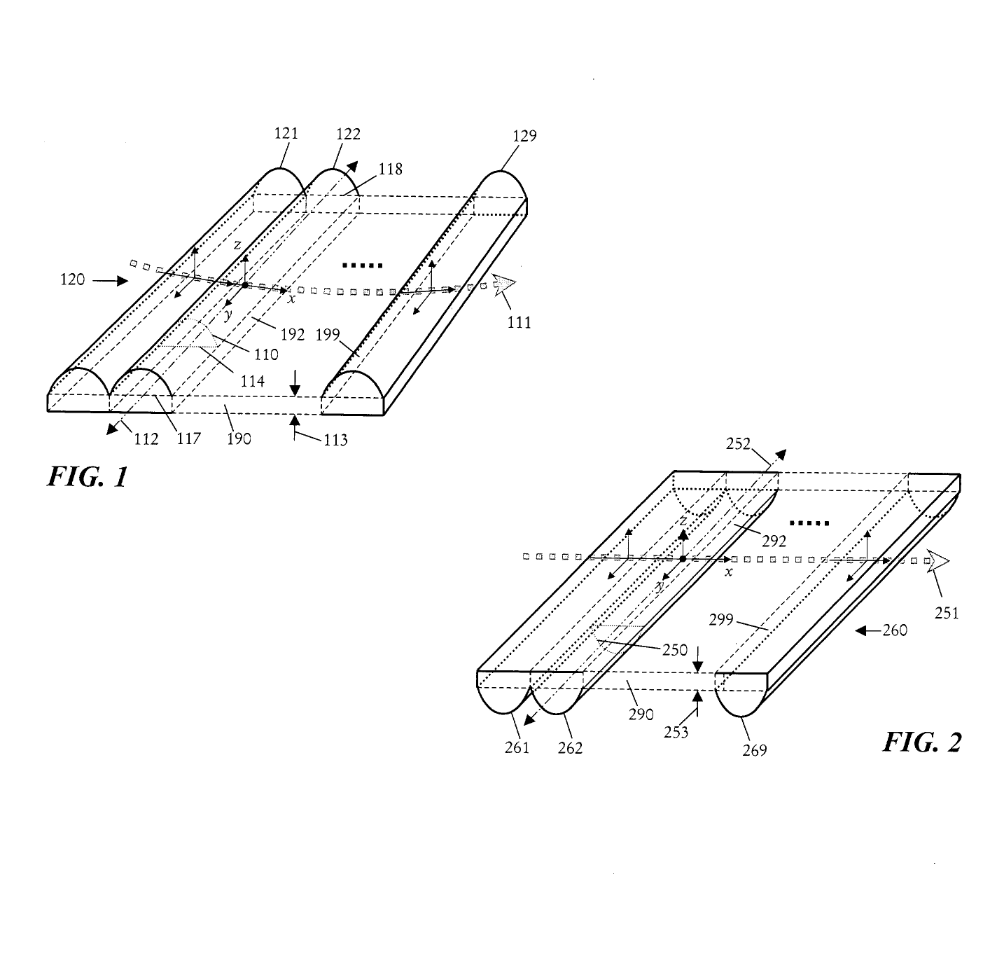

For a description of the inventive optical apparatus, FIGS. 1 and 2 define clearly what a one-dimensional optical array is in the scope of the present invention. FIG. 1 is a perspective view illustrating an array 120 of one-dimensional optical elements 121, 122, . . . and 129 arranged in a plane following a generally curvilinear profile of extension. Similarly, FIG. 2 illustrates another array 260 of one-dimensional optical element 261, 262, . . . and 269 arranged in a plane but following a straight-line profile of extension.

As shown in FIG. 1, an array 120 of one-dimensional optical elements has a number of optical lenses 121, 122, . . . and 129 of the same or similar lens profile arranged in a one-dimensional array. Pursuant to the three-dimensional coordinate system shown in the drawing, the one-dimensional array, 120, of optical elements 121, 122, . . . and 129 extends single-dimensionally in the Y direction, with an optical lens profile 110 expressed as a function of X that is designed for optical path in the Z direction. Size of the lens, or base 114 along the longitudinal (Y) direction of a one-dimensional optical element may be variable. For example, lens profile base 117 at the front end of the element 122 is larger than the base 118 at the remote end. In comparison, the arrays 120 and 260 of FIGS. 1 and 2 respectively are themselves one-dimensional in the X direction, although each of the optical elements 121, 122, . . . and 129 and 261, 262, . . . and 269 for them is itself also generally one-dimensional in nature. As is illustrated, each optical element has a fixed cross-sectional shape anywhere across its longitudinal axis in the Y direction. Within the scope of the disclosure of the present invention, the direction of extension of these arrays of one-dimensional optical elements is referred to as the array extension profile. Thus, the extension profile 251 of the array 260 is a straight line while the extension profile 111 of array 120 is curvilinear.

The substantial construction of an optical apparatus of the present invention utilizing the superposition of two or more thin sheets of physically-separate layered arrays such as those of FIGS. 1 and 2 requires an array base of certain thickness. This base is such as generally identified by reference numerals 190 and 290 for array 120 and 260 respectively. It is comprehensible that if an optical apparatus of the present invention is made as one single layer, the two comprising arrays may then share the same base, such as base 390 illustrated in the optical apparatus 300 of FIG. 3. It should be indicated that the thickness of this base, 113 and 253 for arrays 120 and 260 of FIGS. 1 and 2 respectively, is a convenient parameter that can be manipulated when designing an optical system to specific optical characteristics requirement.

Two or more arrays of one-dimensional optical elements such as that of FIGS. 1 and 2 can be used to construct an optical apparatus to feature desired optical characteristics. The perspective view of FIG. 3 illustrates an embodiment of the optical apparatus in accordance with the teaching of the present invention.

Substantially, the embodiment of FIG. 3 comprises a pair of two arrays of one-dimensional optical elements similar to that of FIG. 1. Both arrays 320 and 360 of the optical apparatus 300 feature a curvilinear extension profile. For example, the curvilinear extension profile 311 of the top array 320 signifies the fact that each of its one-dimensional optical elements 321, 322, . . . and 333 extending generally in the left-right orientation as observed in the drawing has a larger lens profile (110 of FIG. 1) at the right end than at the left. Similarly, in the bottom array 360, far ends of its optical elements 361, 362, . . . and 371 has lens profile sizes larger than at near ends.

In the drawing, the two arrays are illustrated to be superposed one (320) on top of the other (360) with an acute (small) twist angle between the two. This can be observed from the relative angle of crossing between the extension profiles 311 and 351. This acute twist angle is reflected differently across the entire area of the optical apparatus. For example, the local twist angle φ₁ roughly around the intersection between the optical elements 327 and 328 of the top array 320 and elements 364 and 365 is slightly different from the local twist angle φ₂.

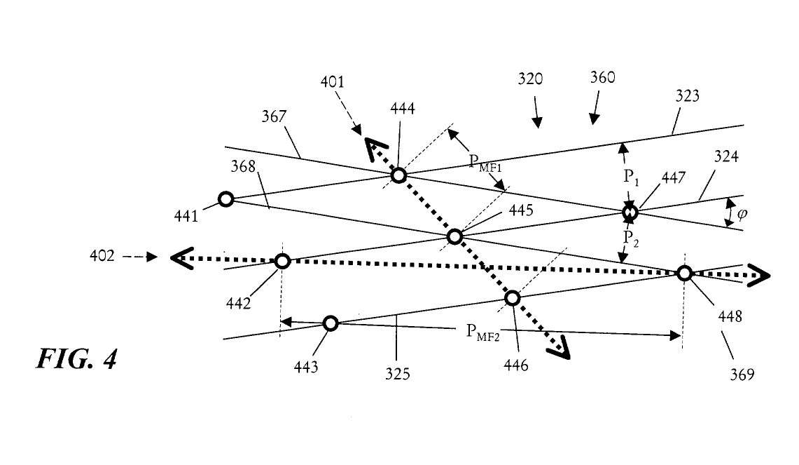

FIG. 4 schematically outlines the matrix positioning of a few of the basic optical units in an embodiment of the optical apparatus of the present invention. Such matrix positioning is the direct result of the twist-angled superposition of two or more arrays of one-dimensional optical elements. The superposition of two arrays of one-dimensional optical elements such as illustrated in FIGS. 1 and 2 produces one unit of optical lens at each and every intersection of any two elements—one from each array. The overall positioning of lens units in the vast matrix becomes one that is known as a moire pattern.

For example, with reference to FIG. 4, a one-dimensional optical element 324 from the top array 320 intersects each of the three elements 367, 368 and 369 of the bottom array 360 at a twist angle φ to form three units of optics. They are lens units 447, 445 and 442 as represented respectively by circles in the drawing. Specifically, each intersection 441, 442, . . . and 448 of any two elements 323, 324, 325, 367, 368 and 369 from each array 320 and 360 is the substantial optical center of a resultant optical unit. As a well-known phenomenon, groups of lens units in the matrix become organized visually to human perception as traces that form the gross moire fringe. For example, lens unit centers represented by circles 444, 445 and 446 in FIG. 4 align to constitute a trace 401 that appears as an eye-catching fringe within the total pattern. By contrast, another trace 402 formed out of centers 442 and 448 would be virtually invisible to human vision.

FIG. 5 schematically outlines an optical apparatus 500 obtained from the superposition of two arrays 520 and 560 of one-dimensional optical elements each featuring straight-line extension profile and fixed element pitch. Since both arrays 520 and 560 have straight-line extension profiles 511 and 551 and fixed repetition pitch of optical elements, the resultant moire fringe formed of the vast matrix of lens units 541 resulting from the array superposition is a relatively more regular one. For example, apparent traces such as 501 become more dominant optically than traces 502 and 503.

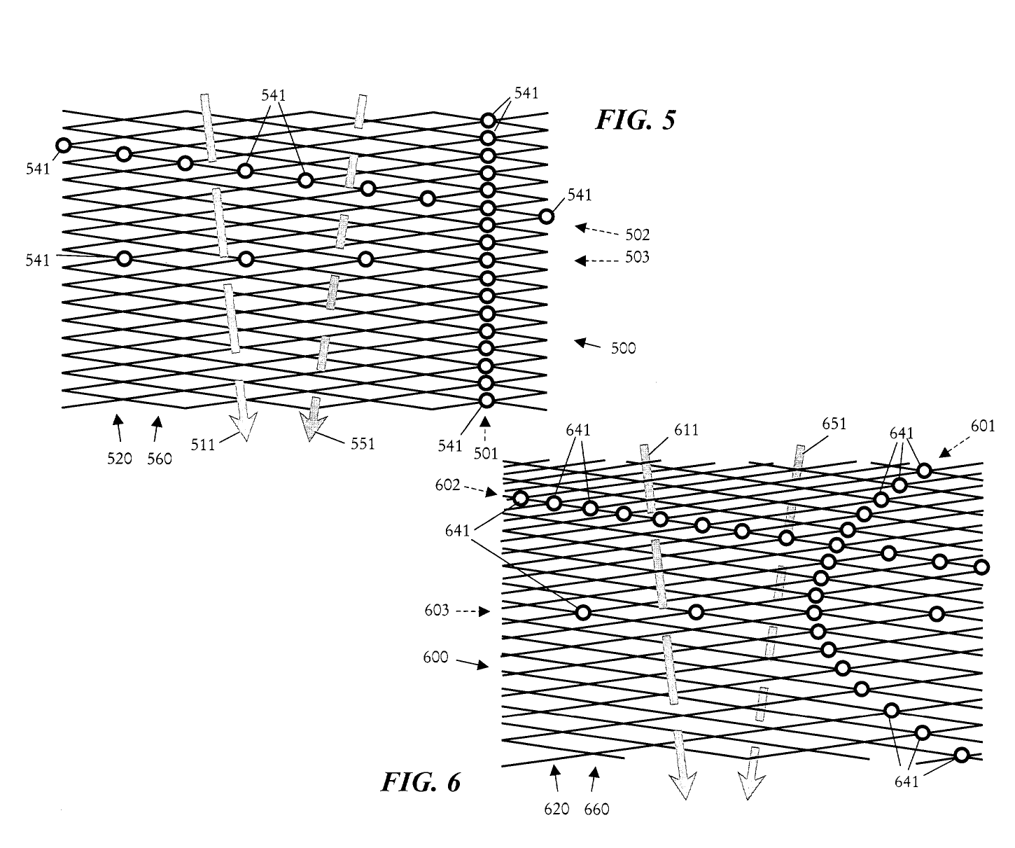

Similarly, FIG. 6 schematically outlines another optical apparatus 600 made out of the superposition of two arrays 620 and 660 of one-dimensional optical elements also both of straight-line extension profiles 611 and 651 respectively. However, one of the arrays, 611, has a varied element pitch. As is illustrated, top elements of array 620 are pitched more densely than those at the bottom. This results into a moire pattern featuring curvilinear traces such as trace 601. In this optical apparatus as depicted, traces 601 are more dominant optically than straight-line traces such as trace 602 and 603 within the same gross pattern.

Thus, in the superposition of arrays of one-dimensional optical elements such as exemplified in FIGS. 5 and 6, all intersections (541, 641) of all elements of the two constituent arrays (520 and 560 of FIG. 5; 620 and 660 of FIG. 6) are aligned in a moire fringe. A fringe features a pattern suitable for the desired optical application, either blurring or imaging.

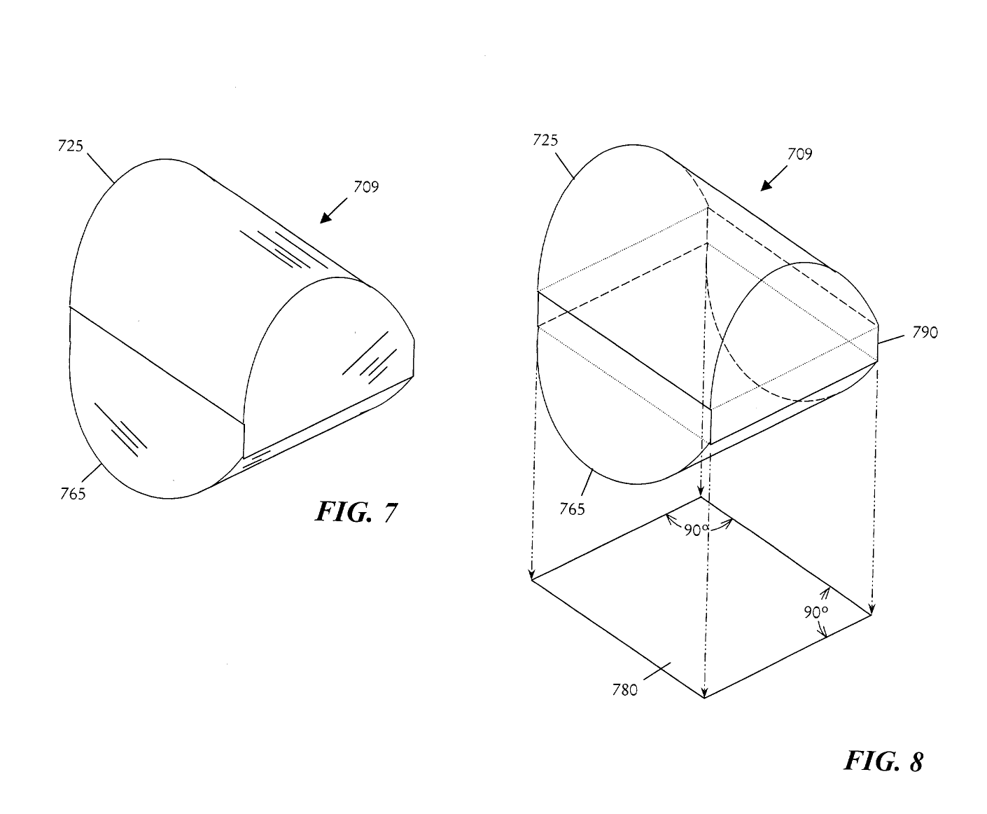

FIG. 7 is a perspective view illustrating one basic optical unit formed integral to an optical apparatus in accordance with a preferred embodiment of the present invention with an orthogonal twist angle between the two comprising arrays. The detailed perspective view clearly shows the one-dimensionality of each of the top and bottom half components of a basic optical unit of the optical apparatus of the present invention. For example, the basic optical unit 709 comprises a top half component 725 and a bottom half component 765. FIG. 8 illustrates the footprint projection of the unit optics 709 of FIG. 7 along the direction of normal optical path. The projected footprint 780 has the basic shape of a rectangle assuming a constant lens profile size for both arrays. This is signified by the 90° right angles found in the contour of the footprint 780.

The perspective view of FIG. 8 also outlines a base 790 for the unit lens 709. This can be considered as a thin layer of lens medium sandwiched between the one-dimensional elements 725 of the top and 765 of the bottom array. The base 790 can also be made of optical medium different from that for the top and bottom elements. For example, it can be vacuum, air, and/or other gas or gases. Or it can also be made of other suitable optical material.

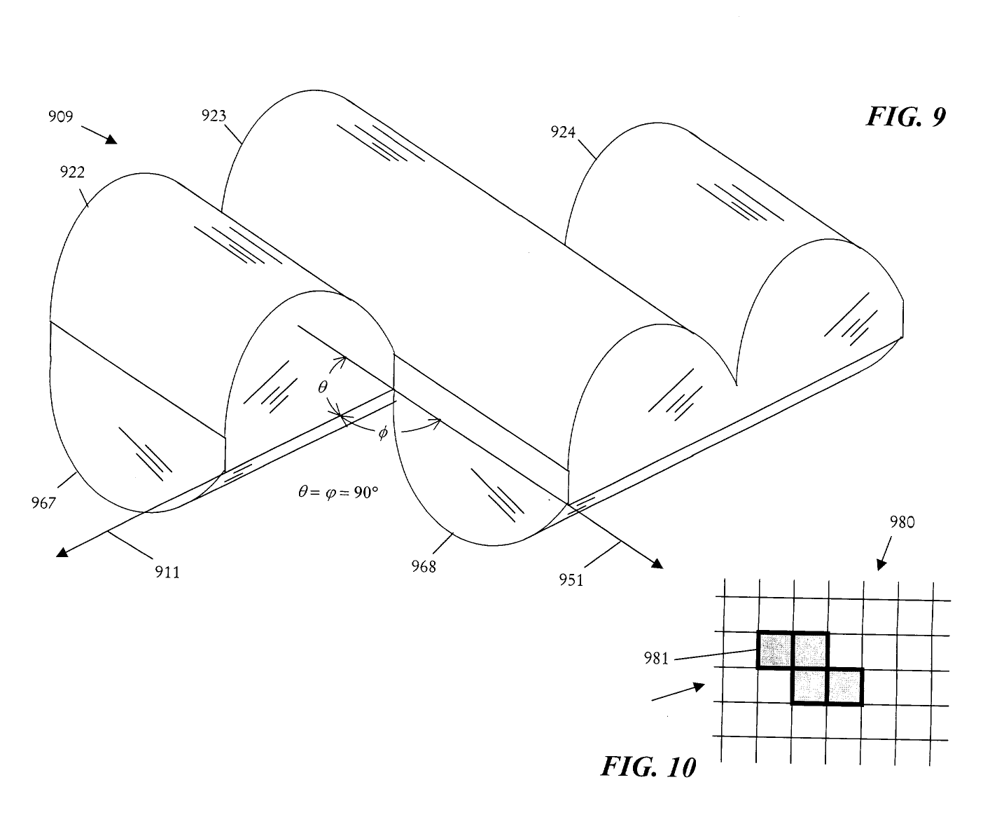

FIG. 9 is a perspective view illustrating a multiple number of the unit optics (709) of FIG. 7 as situated in the vast matrix thereof. The depicted portion, 909, of the gross optical apparatus has three sections one-dimensional optical elements 922, 923 and 924 of its top array shown in the drawing. For the bottom array, two optical element sections, 967 and 968 are shown. The optical element extension profile 911 of the top array and the profile 951 of the bottom are illustrated to be intersecting each other at a right angle of 90°. The top view of FIG. 10 outlines the footprint 981 of the group 909 of selected basic unit optics of FIG. 9. All lens units of the optical apparatus as depicted demonstrate a hundred-percent aperture ratio.

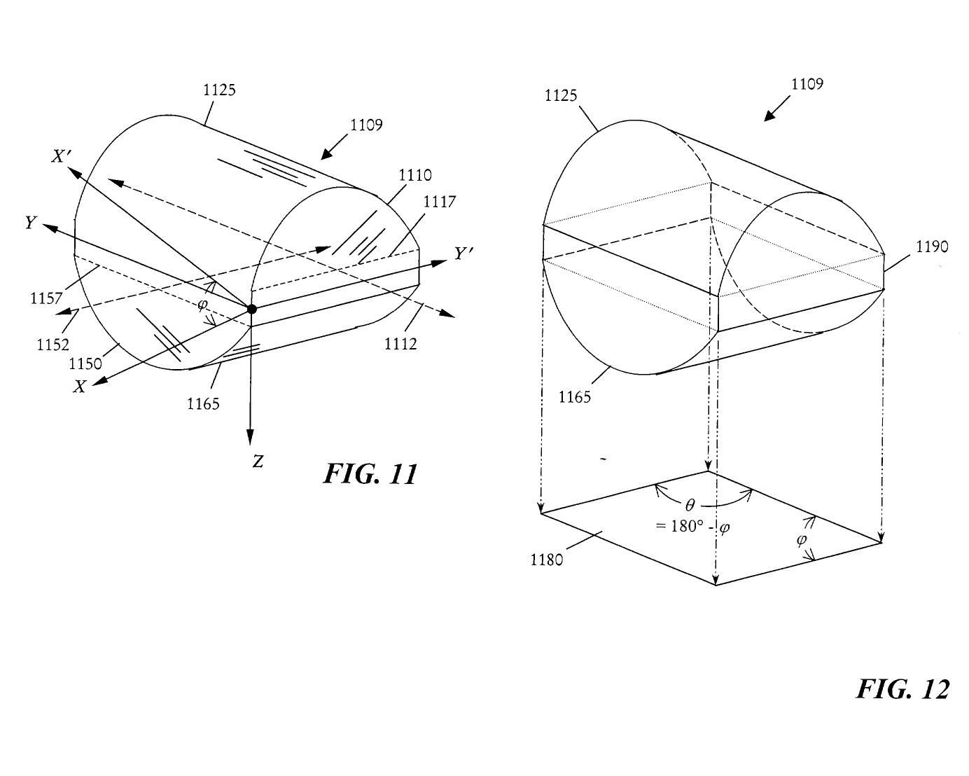

FIG. 11 is a perspective view illustrating another basic optical unit formed integral to an optical apparatus in accordance with a preferred embodiment of the present invention with a small twist angle between the two comprising arrays. The detailed perspective view shows the one-dimensionality of each of the top and bottom half components of a basic optical unit of the optical apparatus of the present invention. Specifically, the basic optical unit 1109 comprises a top half component 1125 and a bottom half component 1165. FIG. 12 illustrates the footprint projection of the unit optics 1109 of FIG. 11 along the direction of normal optical path. The projected footprint 1180 has the basic shape of a parallelogram assuming a constant lens profile size for both arrays. This is signified by an acute angle φ and a complementary angle θ found in the contour of the footprint 1180.

The perspective view of FIG. 12, again, outlines a base 1190 for the unit lens 1109. This base is a thin layer of lens medium sandwiched between the one-dimensional elements 1125 and 1165 of the top and bottom arrays. The base 1190 can also be made of optical medium different from that for the top and bottom elements. Vacuum, air, and/or other gas or gases as well as other suitable optical material are all applicable.

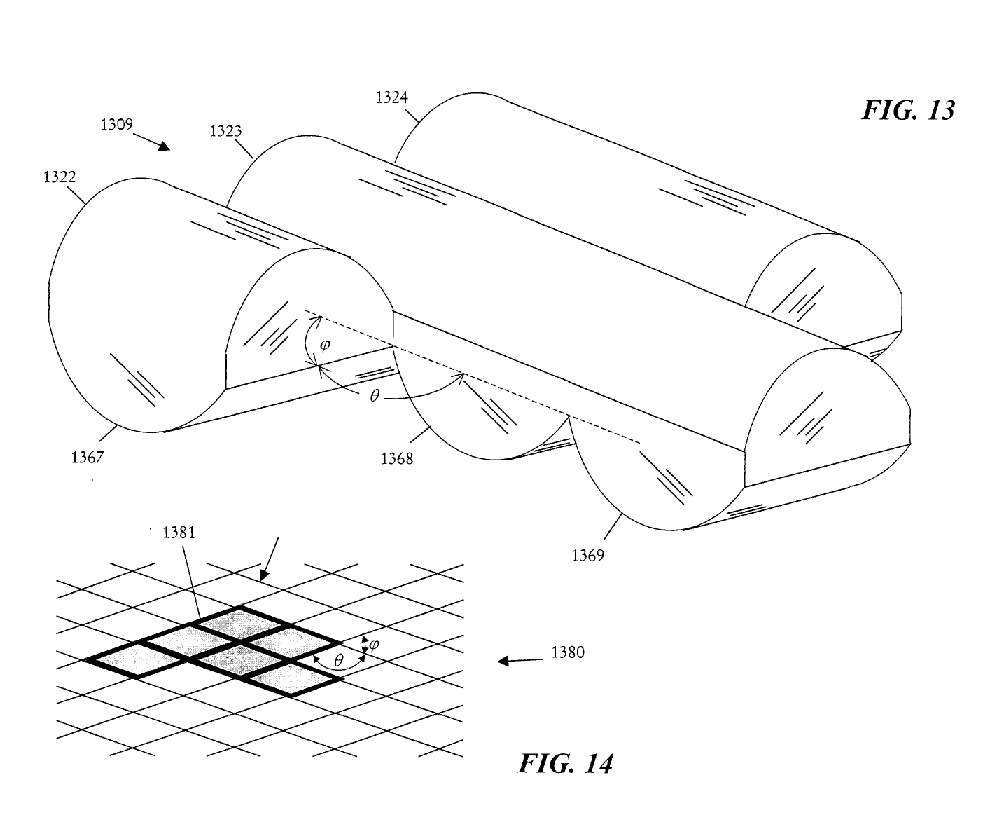

FIG. 13 is a perspective view illustrating a multiple number of the unit optics (709) of FIG. 11 as they are situated in the gross matrix of the inventive optical apparatus. The depicted portion, 1309, of the gross optical apparatus has three sections of one-dimensional optical elements 1322, 1323 and 1324 of its top array shown in the drawing. For the bottom array, three optical element sections, 1367, 1368 and 1369 are shown. The optical element extension profiles of the top and bottom arrays are illustrated to be intersecting each other at a small twist angle φ. The top view of FIG. 14 outlines the footprint 1381 of the group 1309 of selected basic unit optics of FIG. 13. All lens units of the optical apparatus as depicted demonstrate a hundred-percent aperture ratio.

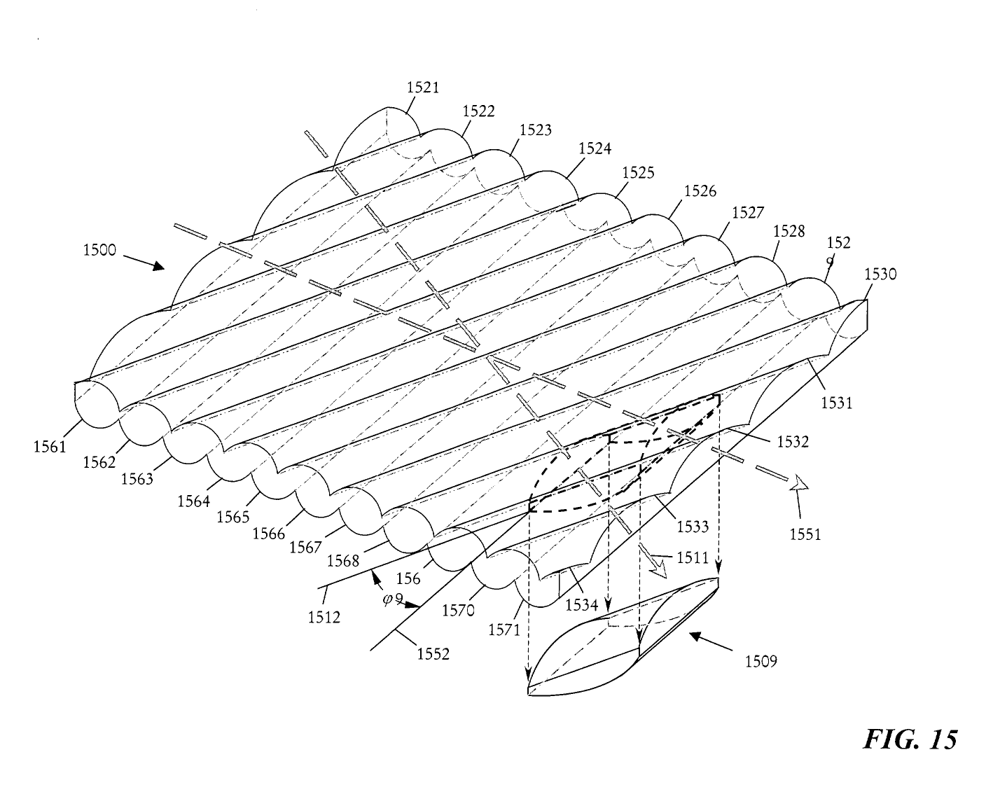

Note here that the lens units 709 and 1109 as depicted in FIGS. 7 and 11 respectively are described above to be comprising two half components (725 and 765, and 1125 and 1165). This is due to the fact that they are the result of superposition of two arrays of one-dimensional optical elements. They, however, become essentially one single pieces (or layer) physically when considering the entire piece of optical system they each are integrated into. For example, FIG. 15 is a perspective view illustrating the shape details of a basic optical unit integrated within the main planer body of an optical apparatus in accordance with a preferred embodiment of the present invention. The embodiment as depicted in FIG. 15 is a portion of an optical apparatus 1500 comprising two arrays of one-dimensional optical elements having straight-line extension profiles 1511 and 1551.

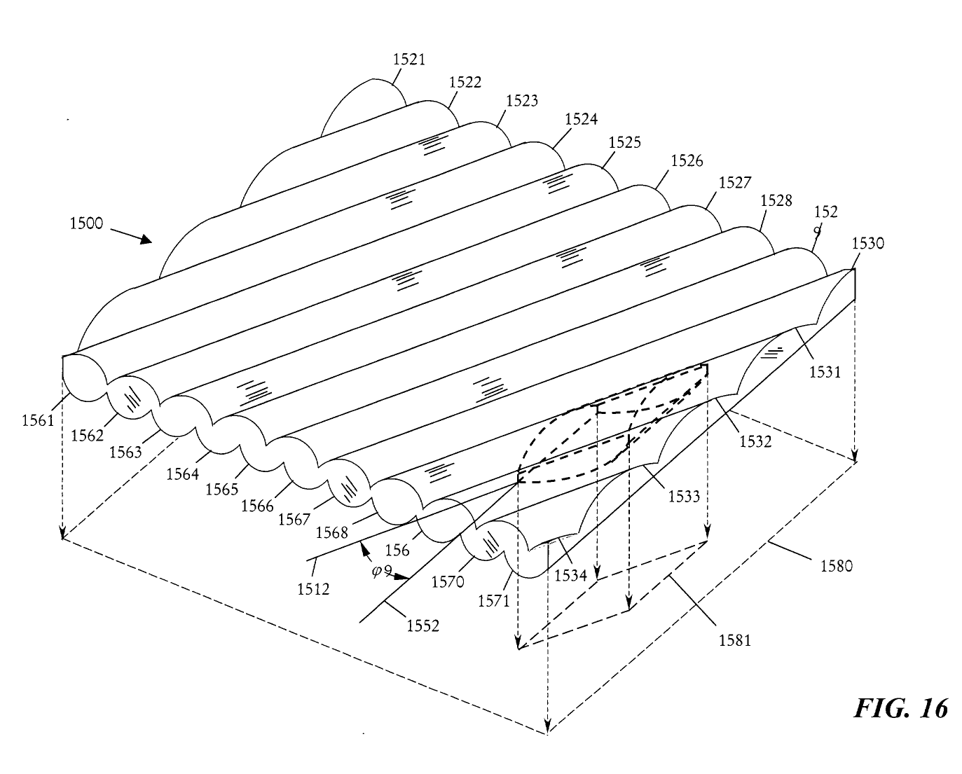

As was in the case of the apparatus of FIG. 3, the portion illustrated in the drawing is a generally rectangular-shaped section of the gross planar optical apparatus, which can be fabricated into a thin sheet of either flat or curved planar nature. In the drawing, a single lens unit identified as unit 1509 has unit boundaries revealing the lens profile cross-sections. FIG. 16 illustrates the footprint projection of the particular unit optics 1509 of FIG. 15 along the direction of normal optical path. The footprint 1581 of the unit lens 1509 is shown at its corresponding location within the entire footprint 1580 of the exemplified section 1500 of the optical apparatus.

In the embodiment of FIG. 15, both two constituent arrays feature one-dimensional optical elements of constant lens profile size, which results into a relatively more regular moire pattern of lens units similar to the one exhibited by the apparatus of FIG. 5. Within this spatial arrangement, the twist angle between the two arrays as measured by the angle φ of intersection by the two longitudinal axes 1512 and 1552 of the top and bottom elements respectively is constant everywhere across the entire surface of the optical apparatus.

A mathematical analysis on a special case of the optical apparatus helps to explain how an optical system to a specific optical characteristics requirement can be constructed in accordance with the teaching of the present invention.

Assuming a lens unit of an optical apparatus of the present invention is shaped at an intersection of two one-dimensional optical elements provided by the top and bottom array of the system. Consider the lens unit 1109 of FIG. 11. Assume both the top and bottom half components 1125 and 1165 are cylindrical lenslets of constant lens shape profiles 1110 and 1150 along their entire longitudinal length. Also assume that each of the shape profiles 1110 and 1150 is one half of a circle, of radius R₁ and R₂ for the top and bottom components respectively. Further assume that both half components are superposed together with their flat bases 1117 and 1157 facing and coinciding each other, and their longitudinal axes, 1112 and 1152, are twisted with respect to each other at an angle φ.

Consider the system 1109 in a coordinate system in which the longitudinal axis of the top half component 1125 is perpendicular to the X and aligned to the Y axis. Base 1117 of half component 1125 is aligned to be perpendicular to the Z axis. Also, let the bottom half component 1165 be similarly aligned in another of its own X′-Y′-Z coordinate system, as is illustrated in FIG. 11. Thus, lens profiles of top and bottom half components 1125 and 1165 can be described in their respective X-Z and X′-Z planes as

x²+z²=R₁² (1)

x′²+z²=R₂². (2)

Paraxial and thin lens models in Fourier optics theory allow for the following approximation in optical transfer function of the system:

$${{ⅇ}^{- i \frac{{x}^{2}}{λ {f}_{1}}}}^{\\} {ⅇ}^{- i \frac{{x}^{′2}}{λ {f}_{2}}} \\ \begin{matrix}= {ⅇ}^{- i \frac{{x}^{2}}{λ {f}_{1}}} {ⅇ}^{- i \frac{{( ax + by )}^{2}}{λ {f}_{2}}} \\ = {ⅇ}^{- i \frac{{x}^{2}}{λ {f}_{1}}} {ⅇ}^{- i \frac{{a}^{2} {x}^{2}}{λ {f}_{2}}} {ⅇ}^{- i \frac{{b}^{2} {y}^{2}}{λ {f}_{2}}} {ⅇ}^{- i \frac{2 abxy}{λ {f}_{2}}} \\ = {ⅇ}^{- i \frac{{x}^{2}}{λ {f}_{x}^{′}}} {ⅇ}^{- i \frac{{y}^{2}}{λ {f}_{y}^{′}}} {ⅇ}^{- i \frac{xy}{λ {f}_{m}^{′}}} \\ = {ⅇ}^{- i \frac{{x}^{2}}{λ {f}_{x}^{′}}} {ⅇ}^{- i \frac{{y}^{2}}{λ {f}_{y}^{′}}} {ⅇ}^{- icxy}\end{matrix} \qquad ( 3 )$$

wherein i=\sqrt{−l}, f₁ and f₂ are focal lengths of the top and bottom half components 1125 and 1165 respectively, and λ is wavelength of incident light. Factors fₓ′ and f_{y}′ are, respectively, the equivalent focal length of the lens unit 1109 in the X-Z and Y-Z plane.

According to component alignments within the coordinate system, there are the relationships α=costφ and b=sinφ. Based on these, factors fₓ′, f_{y}′, and fₘ′, namely lens focus expressed in the translated coordinate system and are more directly descriptive of the characteristics of the optical system, can be related to the original component characteristics as follows:

$$\begin{matrix}{f}_{x}^{′} = \frac{{f}_{1} {f}_{2}}{{f}_{2} + {f}_{1} {cos}^{2} ϕ} & ( 4 ) \\ {f}_{y}^{′} = \frac{{f}_{2}}{{sin}^{2} ϕ} & ( 5 )\end{matrix}$$

and

$${f}_{m}^{′} = \frac{{f}_{2}}{sin 2 ϕ} . \qquad ( 6 )$$

Note that the factor fₘ′ is a measure of the resultant lens unit 1109 observed from 45°.

If the optical system of FIG. 11 as described in Eq. (3) is compared to a conventional spherical lens with a focal length F and described by

$${ⅇ}^{- i \frac{{r}^{2}}{λ F}} = {ⅇ}^{- i \frac{{X}^{2} + {Y}^{2}}{λ F} ,} \qquad ( 7 )$$

then focal length components fₓ′ and f_{y}′ in the X-Z and Y-Z planes allow the lens unit 1109 to be considered analytically an approximation to an ellipsoidal lens.

Theoretical analysis of optical aberrations on the basis of Zernike polynomials allows the two terms fₓ′ and f_{y}′ to be examined and defined as aberration of “astigmatism @ 0° and focus.” Thus, the extent of effective astigmatism present in the lens unit 1109 of FIG. 11 is determined by the discrepancy between fₓ′ and f_{y}′.

Phase component of the term e^{-icxy} to the right of the last equal sign in Eq. (7) becomes cρ² sin 2θ (wherein c=sin 2θ/λf₂ ) after a conversion of coordinate from Cartesian to polar system (x-y—>ρφ). In terms of Zernike polynomials, this corresponds to an aberration of “astigmatism @45° and focus.”

Based on the above, two basic types of optical aberrations are found in lens unit 1109 of FIG. 11. With proper adjustment to factors including lens parameters of the top and bottom half components 1125 and 1165 and the twist angle φ, these two types of aberration can be manipulated to allow the lens unit 1109 to show desired optical characteristics. For example, if the twist angle φ is set to 90° and make fₓ′=f_{y}′, the lens unit 1109 becomes an approximation of a spherical lens, which is suitable for imaging applications. On the other hand, if the twist angle φ is set to about 45° and the focus f₂ of the bottom half component 1165 is made to be significantly smaller relatively, overall aberration of the lens unit 1109 becomes severe, and the system can serve as a blurring device.

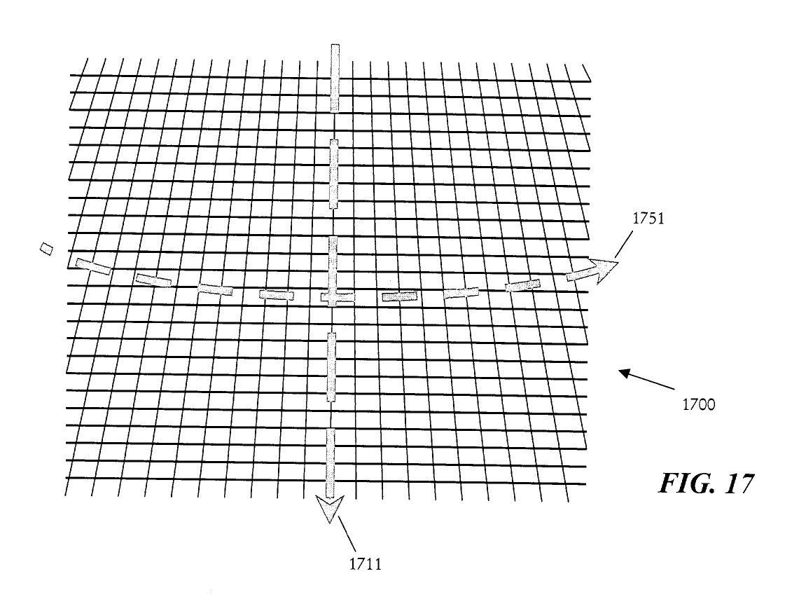

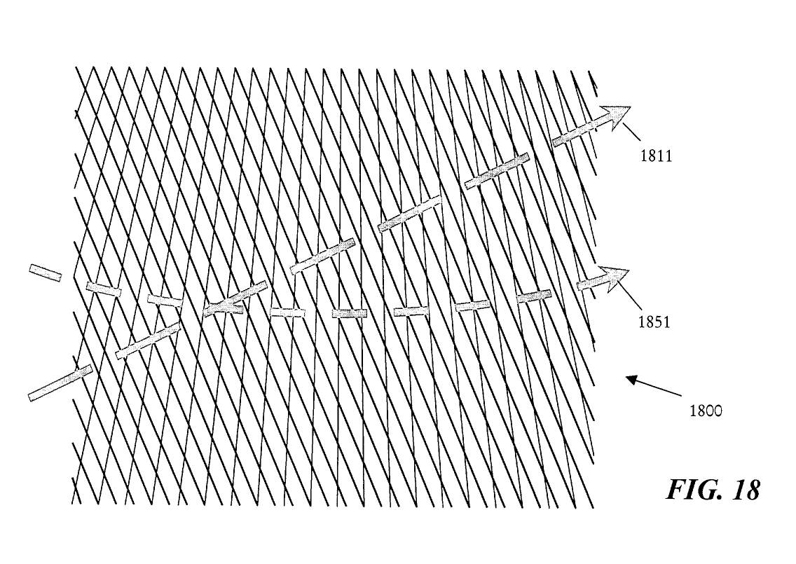

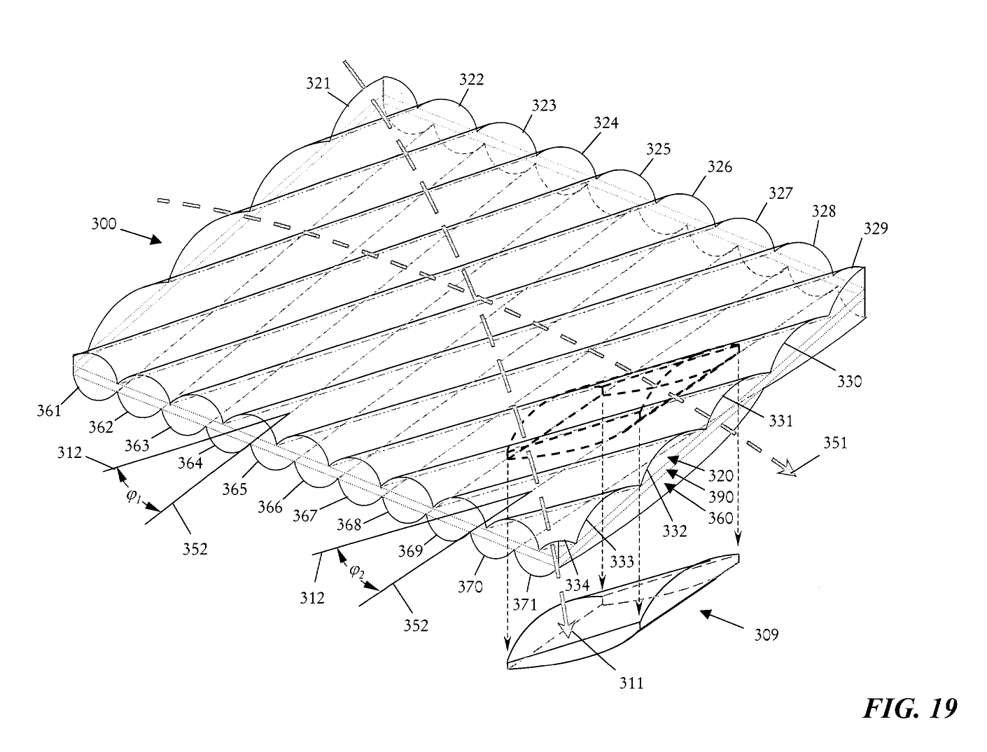

Here it suffices to indicate that the twist angle between the two or more arrays of one-dimensional optical elements constitutes a useful and interesting factor for manipulating the design of an optical system of the present invention. As mentioned, a 90°-twist angle is possible to result into a matrix of lenslets each exhibiting an optical characteristic very similar to a spherical lens. On the other hand, the special case of zero-degree twist angle also results into a special system, which should be considered within the scope of this inventive disclosure. Specifically, consider an optical system with two identical arrays of one-dimensional optical elements featuring the lens profile of half a circle. The two arrays are superposed together at zero twist and aligned with lens profile apices of both along the direction of optical path of the system. Such a system exhibits a special and useful optical characteristic of light collimation. FIG. 17 schematically outlines another superposition of two arrays of one-dimensional optical elements featuring a curvilinear 1751 and a straight-line extension profile 1711. The resultant optical apparatus 1700 of the present invention has a generally orthogonal twist angle between the two constituent arrays as is seen at the crossing of the two extension profiles 1711 and 1751.

By contrast, FIG. 18 schematically outlines yet another superposition of two arrays of one-dimensional optical elements featuring a curvilinear 1851 and a straight-line extension profile 1811. The resultant optical apparatus 1800 has a small twist angle between the two constituent arrays as can be observed by the crossing of the two extension profiles 1811 and 1851.

FIG. 19 is a perspective view illustrating the shape details of a basic optical unit integrated within the main planer body of an optical apparatus in accordance with a preferred embodiment of the present invention. The embodiment shown in FIG. 19 is a portion of an optical apparatus 300 comprising two arrays 320 and 360 of one-dimensional optical elements having curvilinear extension profiles 311 and 351.

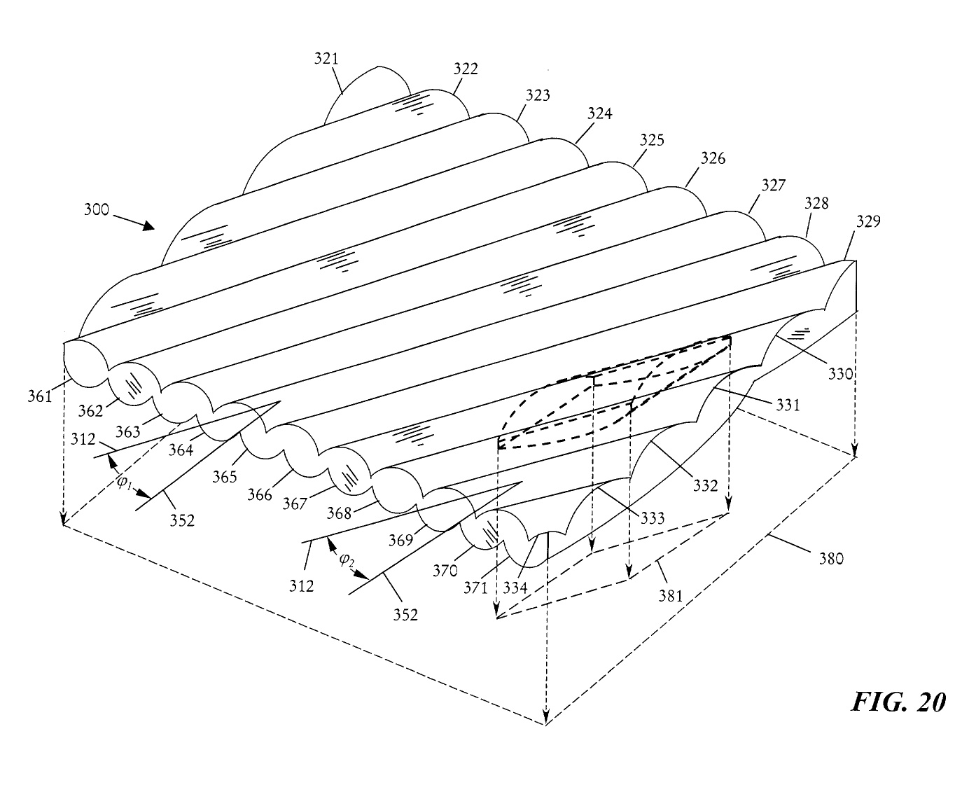

As was in the case of the apparatus of FIG. 3, the portion illustrated in the drawing is a generally rectangular-shaped section of the gross planar optical apparatus, which can be fabricated into a thin sheet of either flat or curved planar nature. In the drawing, a single lens unit identified as unit 309 has unit boundaries revealing the lens profile cross-sections. FIG. 20 illustrates the footprint projection of the particular unit optics 309 of FIG. 19 along the direction of normal optical path. The footprint 381 of the unit lens 309 is shown at its corresponding location within the entire footprint 380 of the exemplified section 300 of the optical apparatus.

In the embodiment of FIG. 19, both of the two constituent arrays feature one-dimensional optical elements of varied lens profile size, exhibiting a relatively more sophisticated moire pattern of lens units. With this spatial arrangement, the twist angle between the two arrays as measured by the angle of intersection by the two longitudinal axes 312 and 352 of the top and bottom arrays of elements respectively is varied at different locations across the entire surface of the optical apparatus. This can be signified by the two different twist angles φ₁ and φ₂ at the two different locations within the apparatus 300.

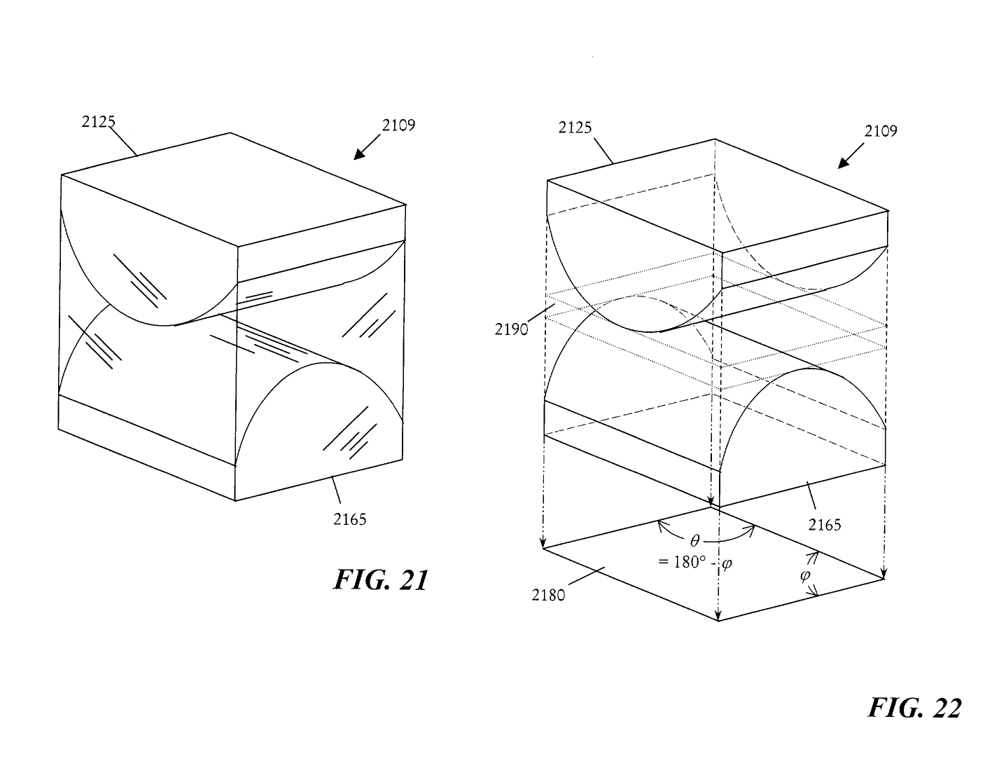

FIG. 21 is a perspective view illustrating one basic optical unit 2109 formed integral to an optical apparatus comprising two arrays of one-dimensional optical elements in accordance with another embodiment of the present invention. FIG. 22 illustrates the footprint projection 2180 of the unit optics 2109 of FIG. 21 along the direction of normal optical path. The lens unit 2109 is similar to the unit 1109 of FIG. 11 except that both arrays are superposed together with the lens profile surfaces of each array facing each other. In this embodiment, the top half component 2125 and the bottom half component 2165 are spaced from each other at a fixed distance, substantially the thickness of the imaginary spacing base layer 2190.

Note that for the entire block body of the lens unit 2109, the spacing between the two half components 2125 and 2165 can only be filled with a light-transmitting medium different from both of the two half components. Vacuum, air, gas or a third material is applicable. If the spacing is filled with a material that is the same as that used to make the two half components 2125 and 2165, the entire lens unit is no longer an optical lens but becomes a simple cubic block.

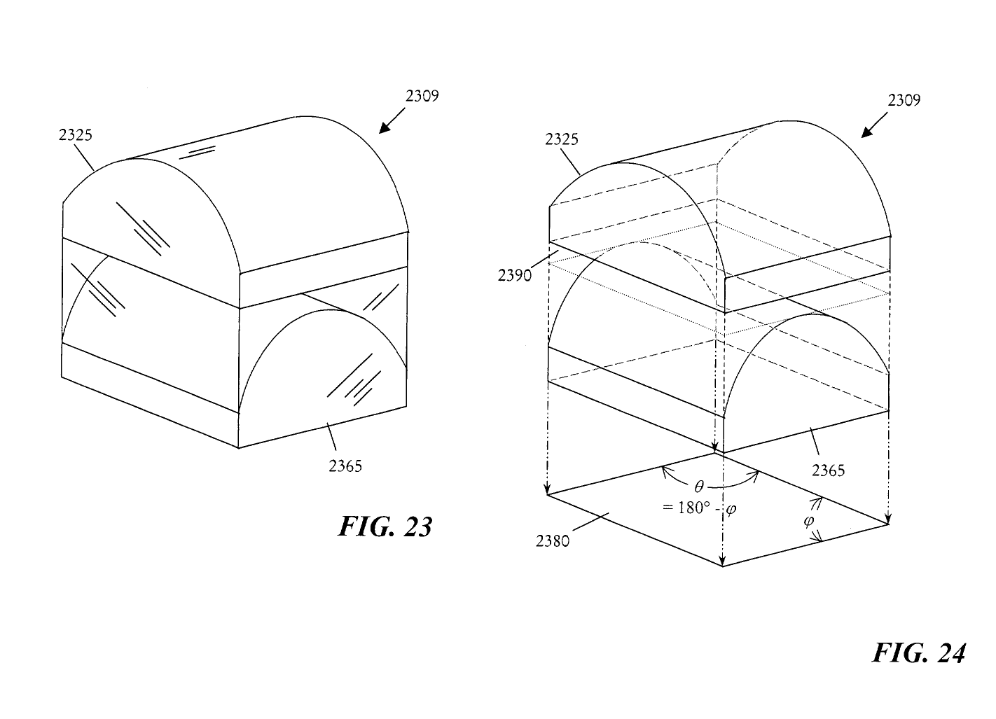

FIG. 23 is a perspective view illustrating one basic optical unit 2309 formed integral to an optical apparatus comprising two arrays of one-dimensional optical elements in accordance with yet another embodiment of the present invention. FIG. 24 illustrates the footprint projection 2380 of the unit optics 2309 of FIG. 23 along the direction of normal optical path. The lens unit 2309 is partly similar to the unit 1109 of FIG. 11 and partly similar to 2109 of FIG. 21. Specifically, the two arrays superposed to make the optical apparatus of the present invention have their lens profile surfaces facing toward the same side of the apparatus. In this embodiment, the top half component 2325 and the bottom half component 2365 are spaced from each other at a fixed distance, substantially the thickness of the imaginary spacing base layer 2390.

For the same reason as that explained for the embodiment of FIG. 21, the spacing between the two half components 2325 and 2365 can only be filled with a light-transmitting medium different from both of the two half components. Vacuum, air, gas or a third material is suitable. If the spacing is filled with a material that is the same as that used to make the two half components 2325 and 2365, the entire lens unit is no longer an optical lens of the present invention. Rather, it becomes a one-dimensional optical element similar to the top half component 2325 itself except for a much thicker base.

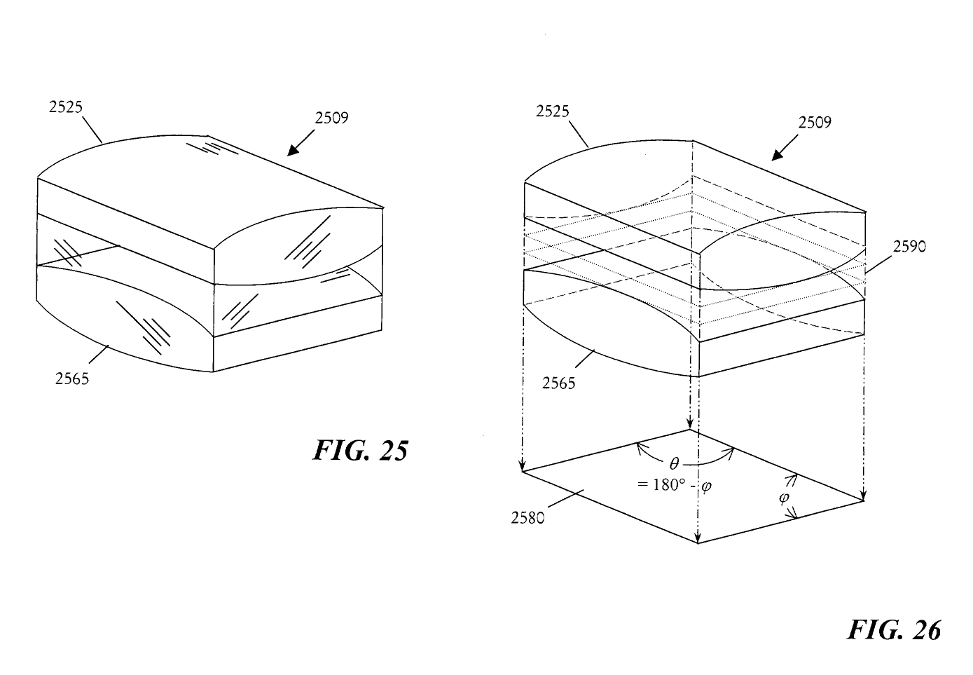

FIG. 25 is a perspective view illustrating one basic optical unit 2509 formed integral to an optical apparatus comprising two arrays of one-dimensional optical elements in accordance with still another embodiment of the present invention. FIG. 26 illustrates the footprint projection 2580 of the unit optics 2509 of FIG. 25 along the direction of normal optical path. When compared to the lens unit 1109 of FIG. 11, the primary difference being the inner surface of both arrays facing each other. In the case of this depicted lens unit 2509, the facing surfaces of the top and bottom half components 2525 and 2565 respectively becomes featured with their own lens profiles instead of plain flat surface.

For the same reason as that for the embodiment of FIG. 23, the spacing between the two half components 2525 and 2565 can only be filled with a light-transmitting medium different from both of the two half components. Vacuum, air, gas or a third material is suitable. If the spacing is filled with a material that is the same as that used to make the two half components 2525 and 2565, the entire lens unit becomes substantially the same as the basic optical unit 1109 of FIG. 11 except for a much thicker overall thickness. Although still an apparatus of the present invention, its optical characteristics would be deviated from that of the lens unit 2509.

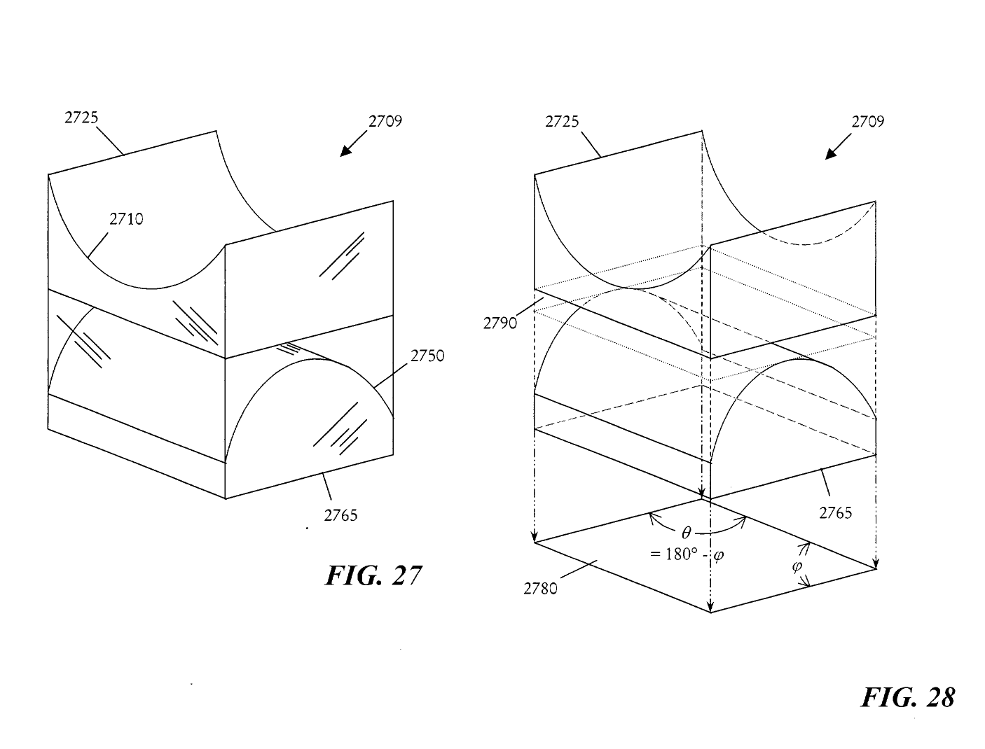

FIG. 27 is a perspective view illustrating yet another basic optical unit of an optical apparatus of the present invention. This embodiment, as demonstrated by the lens unit 2709, is an optical apparatus comprising two arrays of one-dimensional optical elements similar to those described above, but with one of the arrays featuring one-dimensional optical elements having a concave lens profile. Specifically, as is illustrated in the drawing, lens unit 2709 has a top half component 2725 having a lens profile 2710 that is concave in shape. By comparison, the bottom half component 2765 is one with convex lens profile 2750. FIG. 28 illustrates the footprint projection of the unit optics of FIG. 27 along the direction of normal optical path.

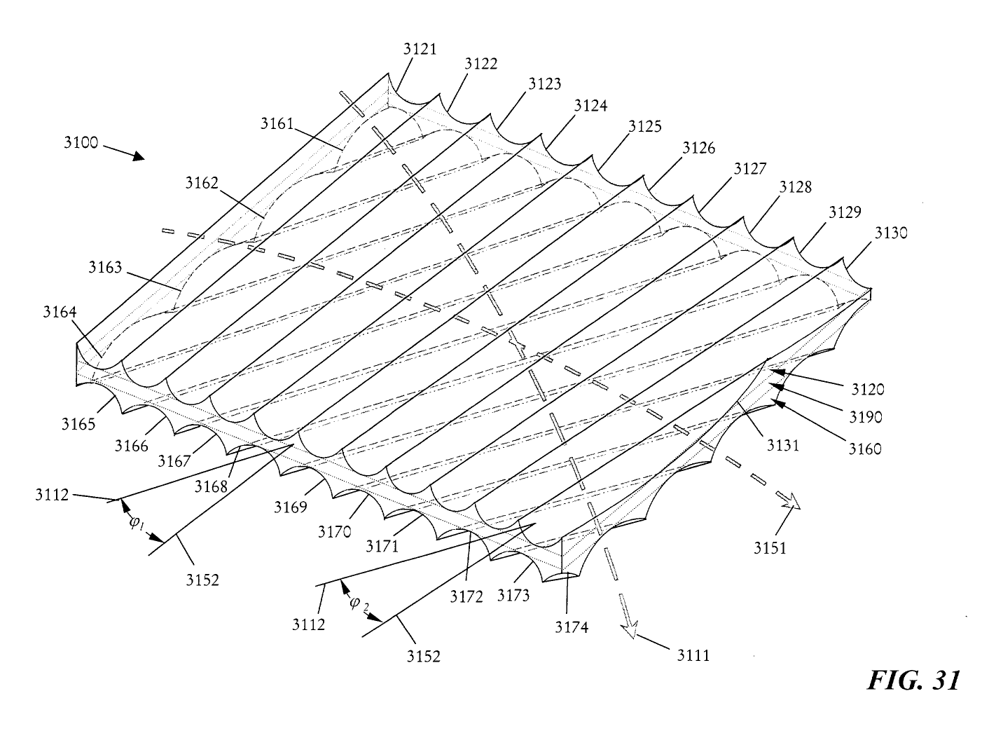

Overall structural details of an optical apparatus of the present invention featuring concave lens profiles is exemplified in the structure shown in FIG. 31. FIG. 31 is a perspective view illustrating a portion of an optical apparatus in accordance with a preferred embodiment of the present invention featuring one-dimensional optical elements with concave lens profiles. Both the top and bottom arrays 3120 and 3160 of the system 3100 employ one-dimensional optical elements with concave lens profiles. Note the base layer 3190 between the two arrays. Though, due to the relative twisting of the two arrays, it is possible to make the thickness of this base 3190 as small as possible.

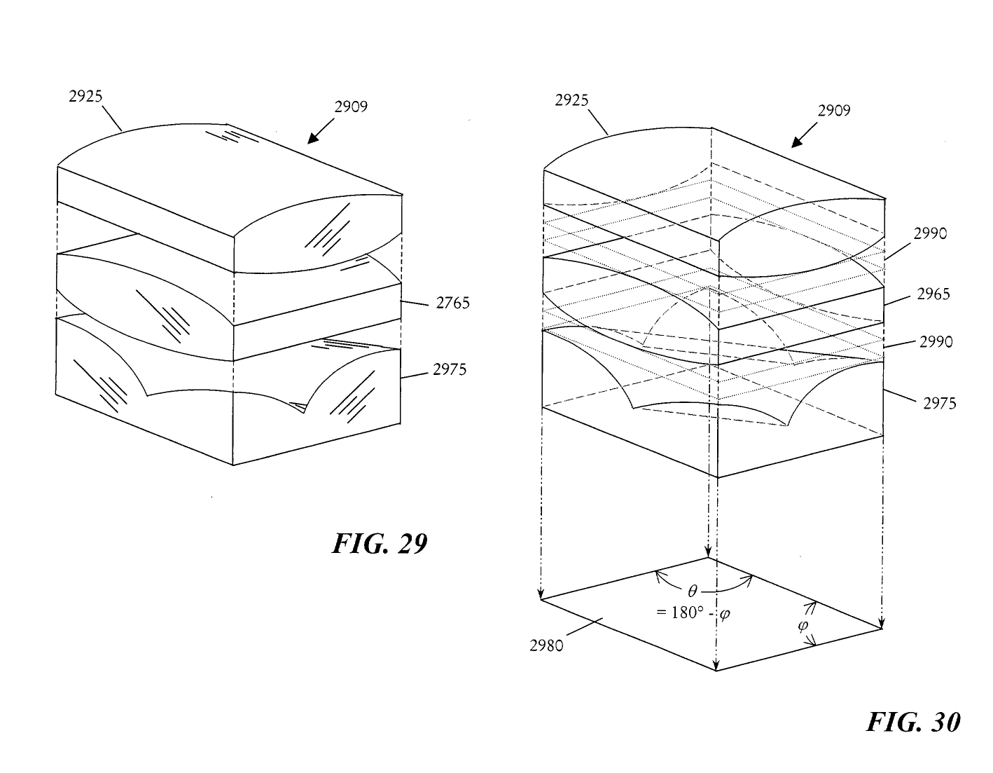

FIG. 29 is a perspective view illustrating one basic optical unit 2909 formed integral to an optical apparatus comprising three arrays of one-dimensional optical elements in accordance with an embodiment of the present invention. FIG. 30 illustrates the footprint projection 2980 of the unit optics 2909 of FIG. 29 along the direction of normal optical path. This particular lens unit 2909 is different from all other units described previously in that three, instead of two, arrays of one-dimensional optical elements are employed for the construction of the optical apparatus of the present invention. In the depicted example, the top and center partial components 2925 and 2965 are the same as the top and bottom half components 2525 and 2565 respectively of the unit 2509 of FIG. 25. An additional third partial component 2975 is further superposed together. As is seen in the drawing, this third one-dimensional component 2975 as employed in this embodiment has the longitudinal axis thereof aligned to a direction different from that of both the partial components 2925 and 2965.

For the same reason as that explained above, the two spacing 2990 between the three partial components 2925, 2965 and 2975 can only be filled with a light-transmitting medium different from all three of the partial components. Vacuum, air, gas or a third material is suitable. If the spacing is filled with a material that is the same as that used to make the three partial components 2925, 2965 and 2975, the entire lens unit becomes substantially another one-dimensional optical element except that the overall thickness becomes excessively large.

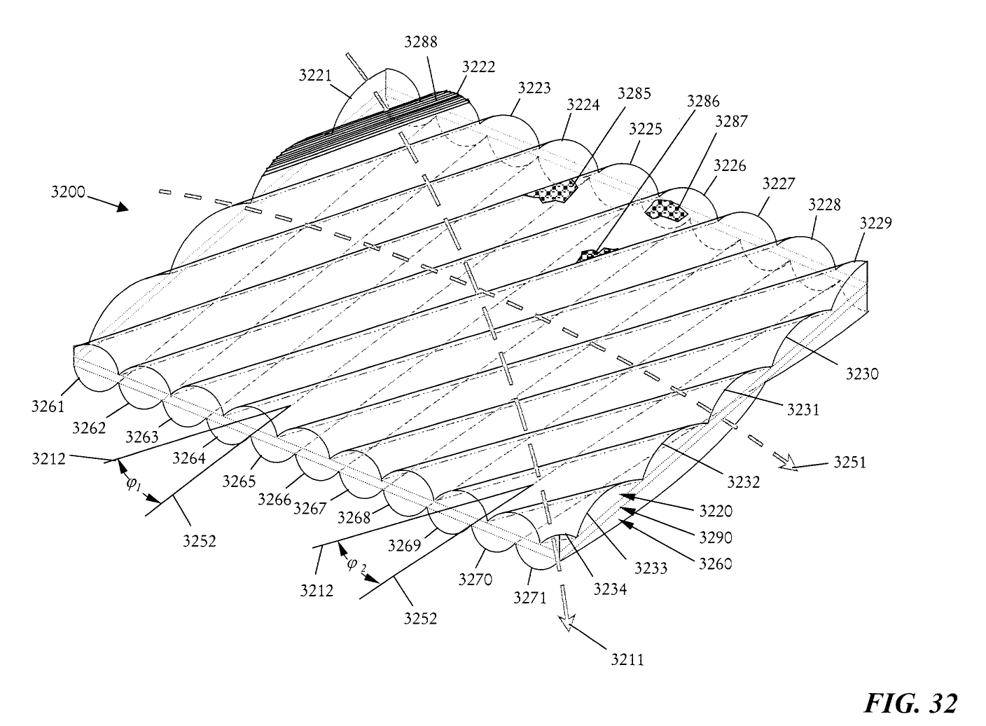

As mentioned above, selection of a specific set of design parameters for an optical system allows the construction of an optical apparatus specifically for light smearing application such as required in the diffuser of the backlight module of an LCD display. Structures similar to those illustrated in various drawings described above are suitable for the construction of light-smearing diffuser panels. Though, those structures can have their light smearing capability further enhanced easily. FIG. 32 is a perspective view illustrating the optical apparatus of FIG. 3 further featuring distributed local ground surface areas that enhance light smearing.

This simple means of light-smearing capability enhancement involves the formation of local roughness areas distributed according to selected distribution pattern over the surface of the optical system. As is illustrated in FIG. 32. An optical system similar to that of FIG. 3 has ground surface areas such as those identified by reference numerals 3285, 3286, 3287 and 3288 formed on the external surface of the top array 3220. These local surface roughness areas can be prepared in various ways possible. For example, they can be ground surface areas formed after the formation of the entire sheet of optical system 3200. Or, they can be formed at the same time as the system 3200 itself if fabrication methods such as hot pressing or mold casting are adopted.

Roughness of each of the local areas can be of any suitable and convenient surface characteristics. They can be two-dimensional random roughness across the entire local area, as is exemplified by areas 3285, 3286 and 3287. Or, they can also be one-dimensional surface roughness such as roughness area 3288. Such one-dimensional surface roughness can in fact be visualized as being formed by the extension of the lens surface profile of the optical element 3222, whose lens profile has a one-dimensional random roughness across a section of the entire stretch of its lens profile.

Size and shape of each of the local surface roughness areas can be adjusted according to need. Note that the drawing of FIG. 32 serves only to explain how these local surface roughness areas can be spread over the surface of an optical apparatus. More roughness areas with different sizes, shapes and pattern of distribution than those shown in the drawing are possible. Also, location of these local surface roughness areas is not restricted to the one surface of the system, as is the case shown in FIG. 32. Roughness areas on the opposite surface are also allowed.

Presence of these local surface roughness areas over the surface of an optical apparatus of the present invention contributes to enhance the total light smearing capability of a system designed for just such application. This enhancement is particularly advantageous for applications such as the smearing of LED light sources in devices such as high-intensity LED-based lighting and video displays.

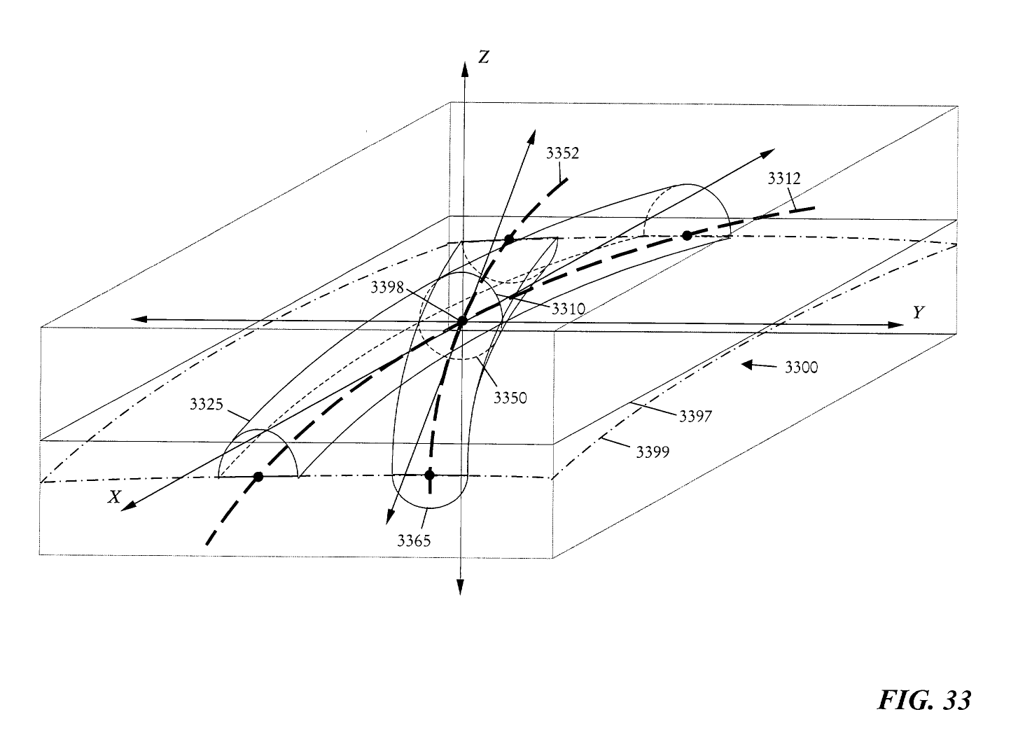

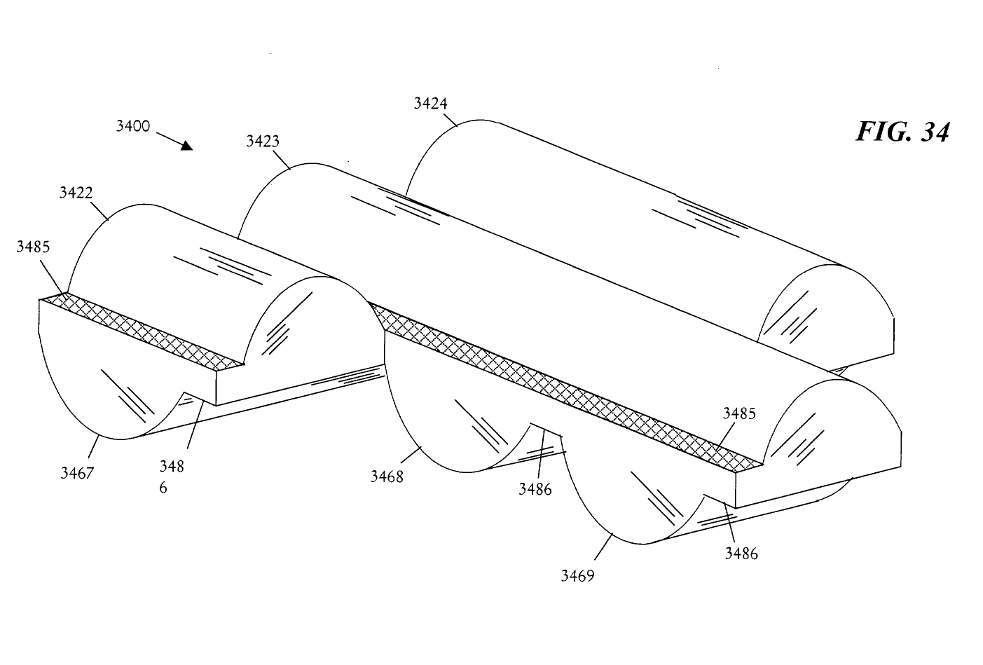

FIG. 33 is a perspective view illustrating a section of an optical apparatus of the present invention having two arrays of one-dimensional optical elements and sustaining the shape of a generally curved plane. In the system 3300 shown, only one one-dimensional optical element in each of the two arrays is shown in the drawing. They are element 3325 of the top array and 3365 of the bottom. Note that both elements 3325 and 3365 of the two component arrays are generalized one-dimensional optical element. This is illustrated in the drawing by the curvilinear longitudinal axes, 3312 and 3352, of the top and bottom half components, 3325 and 3365 respectively.

Assuming the system 3300 of FIG. 33 is illustrated with the center of intersection between the two elements as identified in the drawing by dot 3398 set to the original of the three-dimensional coordinate system. Also assume that the optical apparatus 3300 is aligned in the coordinate system so that both longitudinal axes of the two one-dimensional elements are tangent to the X-Y plane 3397 of the coordinate system simultaneously at the point of intersection 3398. Such an optical apparatus 3300 extends a curved surface that is outlined in the drawings as plano-convex surface 3399 that is convex toward the top end of the Z coordinate axis.

Thus, as compared to the other embodiments described in the previous paragraphs, the optical apparatus 3300, instead of being flat as a thin sheet, extends into a surface of curvature. Typical instances for light-diffusing applications include, among others, a mask to smear the large number of LED lamps installed in the tail light assemblies of automobiles.

The basic optical units resulting from the superposition and intersection of arrays of one-dimensional optical elements in accordance with the teaching of the present invention are described generally as lens units in various embodiments. Though, they can also be small lenses down in size to the scale generally known as microlenses. An optical apparatus of the present invention is particularly suitable for miniaturization due to its simplicity in fabrication.

In summary, as an averaging diffuser for the blurring of illumination light source with local bright, an optical apparatus of the present invention is one comprising a gross two-dimensional matrix of basic optical units. Each unit in the gross matrix system of micro optical lenses is constructed out of the combination of multiple—at least two—one-dimensional optical elements, which is an elongated lens with featured profile shape and extends one-dimensionally as a column, or cylinder, in the longitudinal direction. The combination herein involves the superposition of the multiple arrays at twisted angle and generates a pattern of optical lens units resulting from the twisted superposition that is effectively a moire fringe. The patterning of all the optical lens units as a whole blurs and averages an originally uneven illumination light source. Local bright in the surface illumination light source thus become smeared and invisible to human eyes.

On the other hand, when made for applications involving precision imaging, an optical apparatus of the present invention can be one similarly constructed but with different lens profile shape for its optical elements. The lens profiles are adjusted so that the lens units resulting from the twisted superposition become precision imaging optical units. Also, since all the lens units resulting from the superposition of two or more one-dimensional optical element arrays sustain hundred-percent aperture ratio, an optical system thus constructed sustains minimum optical loss. Except for the factor due to the material selected for the manufacture, an optical apparatus of the present invention sustains virtually zero light loss as a whole.

Further, all the preferred embodiments of the optical apparatus of the present invention described above sustain hundred-percent aperture ratios to achieve maximum possible optical efficiency. This is possible with their hundred-percent aperture ratio lens units arrayed in their entire moire fringe matrices. Light loss is limited only to optical material. There is, however, another factor also attributable to the achieved optimized optical efficiency of the inventive optical system. Specifically, all optical system of constructed in accordance with the teaching of the present invention can be categorized as phase moire optical devices.

The reference to the inventive system as phase moire is due the fact that only phase shifts are involved in the inventive system as light pass through the light-transmitting medium of the construction. Light transmissions through optics of the inventive system involve pure reflection and refraction—phase—only. No amplitude loss is incurred to produce grayscale phenomenon in turn. On the other hand, moire here refers to the relation to the well-known phenomenon. The at least two arrays of one-dimensional optical elements are, according to the present invention, superposed at a twist angle to “result into” an optical system, and the resultant two-dimensional matrix of unit lenses exhibits what is conventionally known a moire fringe. When compared to amplitude moire optical devices, no grayscale phenomenon is present in the inventive system to consume light that reduces overall optical efficiency.

Mixed phase-amplitude moire optical systems according to the present invention are possible. FIG. 34 depicts such a system. A system 3400 according to the present invention has two arrays of one-dimensional optical elements of similar lens profile. Lens profile for the optical elements in the arrays is special in that a section of the entire profile is generally an arc of a circle and the rest being generally linear but featured with random or pre-specified roughness. From an optical perspective, the optical profile of a smooth arc of a circle serves primarily to modify the phase, not the amplitude, of the incident light beams, which is the essential feature of a phase element. On the other hand, the part featured with random or pre-specified roughness effects both the amplitude and the phase of the incident beam. Thus, as is illustrated, each of the elements 3422, 3423 and 3424 of the top array has an elongated stripe of flat rough surface 3485. Similarly, element 3467, 3468 and 3469 of the bottom array has an elongated stripe of flat rough surface 3486, although not directly visible in the drawing. These stripes of rough surface are similar to those described in FIG. 32 and serve the same purpose of light smearing. These rough-surface areas on the surface of the optical system 3400 can be considered phase-amplitude sections as compared to the phase-only sections of the circular lens profile.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. An optical apparatus comprising:
at least two superposed arrays of one-dimensional optical elements; wherein each of said arrays including a plurality of elongated cylindrical optical elements arrayed consecutively in parallel and spreading along an extension-profiling direction generally orthogonal to the longitudinal axes thereof;
each of said at least two arrays being superposed with each of the other arrays having said general direction of extension-profiling thereof twisted an angle away from the general direction of extension-profiling of said each of the other arrays; and
said superposition spreading an extended layer of optical system having a plurality of lens units resulting from said superposition and arrayed in a two-dimensional matrix.

2. The optical apparatus of claim 1, wherein the lens profile of said one-dimensional optical elements of at least one of said at least two arrays is a convex profile.

3. The optical apparatus of claim 1, wherein the lens profile of said one-dimensional optical elements of at least one said at least two arrays is a concave profile.

4. The optical apparatus of claim 1, wherein at least one of said arrays of one-dimensional optical elements have a distribution of local areas with surface roughness.

5. The optical apparatus of claim 4, wherein said distribution of local areas with surface roughness is in conformity to a pattern wherein said apparatus producing a predetermined light distribution upon illumination by a light source.

6. The optical apparatus of claim 1, wherein each of said plurality of lens units is a defocusing lens unit.

7. The optical apparatus of claim 1, wherein each of said plurality of lens units is a focusing lens unit.

8. The optical apparatus of claim 1, further comprising at least a layer of light-transmitting medium sandwiched between two consecutive ones of said at least two arrays.

9. The optical apparatus of claim 8, wherein said light-transmitting medium is air.

10. The optical apparatus of claim 1, wherein the general direction of extension-profiling of at least one of said arrays is curvilinear and said optical apparatus spreads an extended layer of curved surface.

11. The optical apparatus of claim 1, wherein the general direction of extension-profiling of at least one of said arrays is a straight line and said optical apparatus spreads an extended layer of flat surface.

12. The optical apparatus of claim 11, wherein each of said plurality of lens units is a defocusing lens unit.

13. The optical apparatus of claim 11, wherein each of said plurality of lens units is a focusing lens unit.

14. An optical apparatus comprising:
two superposed arrays of one-dimensional optical elements; wherein each of said arrays including a plurality of elongated cylindrical optical elements arrayed consecutively in parallel and spreading along an extension-profiling direction generally orthogonal to the longitudinal axes thereof;
each of said two arrays being superposed with the other array having said general direction of extension-profiling of said two arrays twisted at an angle; and
said superposition spreading an extended layer of optical system having a plurality of lens units resulting from said superposition and arrayed in a two-dimensional matrix.

15. The optical apparatus of claim 14, wherein the lens profile of said one-dimensional optical elements of at least one of said two arrays is a convex profile.

16. The optical apparatus of claim 14, wherein the lens profile of said one-dimensional optical elements of at least one said two arrays is a concave profile.

17. The optical apparatus of claim 14, wherein at least one of said arrays of one-dimensional optical elements have a distribution of local areas with surface roughness.

18. The optical apparatus of claim 17, wherein said distribution of local areas with surface roughness is in conformity to a pattern wherein said apparatus producing a predetermined light distribution upon illumination by a light source.

19. The optical apparatus of claim 18, further comprising a light guide sandwiched between said two arrays of one-dimensional optical elements for guiding said illumination of said light source, wherein one of said two arrays of one-dimensional optical elements is embossed on one side of said light guide and the other of said two arrays of one-dimensional elements is embossed on the other side of said light guide.

20. The optical apparatus of claim 14, wherein the general direction of extension-profiling of at least one of said arrays is a straight line and said optical apparatus spreads an extended layer of flat surface.

21. The optical apparatus of claim 20, wherein each of said plurality of lens units is a defocusing lens unit.

22. The optical apparatus of claim 21, further comprising a light guide sandwiched between said two arrays of one-dimensional optical elements, wherein one of said two arrays of one-dimensional optical elements is embossed on one side of said light guide and the other of said two arrays of one-dimensional elements is embossed on the other side of said light guide.

23. The optical apparatus of claim 21, wherein said twisted angle is an acute angle.

24. The optical apparatus of claim 20, wherein each of said plurality of lens units is a focusing lens unit.

25. The optical apparatus of claim 24, wherein said twisted angle is substantially a right angle.

26. An optical apparatus comprising:
a first array of one-dimensional optical elements, said first array including a plurality of elongated cylindrical optical elements arrayed consecutively in parallel and spreading along a first extension-profiling direction generally orthogonal to the longitudinal axes thereof; and
a second array of one-dimensional optical elements, said second array including a plurality of elongated cylindrical optical elements arrayed consecutively in parallel and spreading along a second extension-profiling direction generally orthogonal to the longitudinal axes thereof, said second array being superposed with said first array having said general direction of extension-profiling of said two arrays twisted at an angle; and said superposition spreading an extended layer of optical system having a plurality of lens units resulting from said superposition and arrayed in a two-dimensional matrix.

27. The optical apparatus of claim 26, wherein the lens profile of said one-dimensional optical elements of at least one of said first and second arrays is a convex profile.

28. The optical apparatus of claim 26, wherein the lens profile of said one-dimensional optical elements of at least one said at first and second arrays is a concave profile.

29. The optical apparatus of claim 26, wherein at least one of said arrays of one-dimensional optical elements have a distribution of local areas with surface roughness.

30. The optical apparatus of claim 29, wherein said distribution of local areas with surface roughness is in conformity to a pattern wherein said apparatus producing a predetermined light distribution upon illumination by a light source.

31. The optical apparatus of claim 26, further comprising a light guide sandwiched between said first and second arrays of one-dimensional optical elements, wherein said first arrays of one-dimensional optical elements is embossed on one side of said light guide and said second arrays of one-dimensional elements is embossed on the other side of said light guide.

32. The optical apparatus of claim 26, wherein the general direction of extension-profiling of at least one of said two arrays is a straight line and said optical apparatus spreads an extended layer of flat surface.

33. The optical apparatus of claim 32, wherein each of said plurality of lens units is a defocusing lens unit.

34. The optical apparatus of claim 33, further comprising a light guide sandwiched between said two arrays of one-dimensional optical elements, wherein one of said two arrays of one-dimensional optical elements is embossed on one side of said light guide and the other of said two arrays of one-dimensional elements is embossed on the other side of said light guide.

35. The optical apparatus of claim 34, wherein said twisted angle is an acute angle.

36. The optical apparatus of claim 32, wherein each of said plurality of lens units is a focusing lens unit.

37. The optical apparatus of claim 36, wherein said twisted angle is substantially a right angle.
